(19) United States
(12) Patent Application Publication
(10) Pub. No.: US 2012/0097410 A1
(43) Pub. Date: Apr. 26, 2012

(54) Tool

(76) Inventor: Thomas W. Honsa, Milan, IL (US)

(21) Appl. No.: 13/281,751

(22) Filed: Oct. 26, 2011

Related U.S. Application Data
(60) Provisional application No. 61/406,824, filed on Oct. 26, 2010.

(51) Int. Cl. B25D 17/24

(52) U.S. Cl. 173/162.2

(57) ABSTRACT

One embodiment of a tool generally comprises a skeleton, barrel, valve box assembly, and a throttle assembly. A sleeve may also be included to cover a portion of the skeleton. The skeleton may include a main body with a handle member protruding therefrom, wherein a throttle void may be formed intermediate to the main body and handle member. The throttle assembly may be configured such that the actuation of the throttle is in a direction substantially perpendicular to the handle member, which allows periphery of the handle member to be less than it would in a parallel configuration. A sleeve fashioned of energy absorbing and/or vibration damping material may be positioned over a portion of the skeleton. A handle integrally formed with the sleeve may cover the handle member to increase the ergonomic features of the tool.

### CROSS REFERENCE TO RELATED APPLICATIONS

Applicant claims priority from provisional U.S. Pat. App. No. 61/406,824 filed on Oct. 26, 2010, which is incorporated by reference herein in its entirety.

### FIELD OF INVENTION

The present invention relates to hand tools, and more specifically, pneumatic and/or electric percussive tools.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND

Portable tools of the type forming the subject matter of this application are usually percussion tools; that is, pneumatically or electrically powered and comprise such mechanisms as hammers, chippers, drills, grinders weld-destruct tools and the like. However, the present disclosure is applicable to other types of portable tools as well, such as those powered by small internal-combustion engines; e.g., grass and weed trimmers of the string type, edgers, hedge clippers.

Of all tools of this general class, the pneumatic hammers and chisels or chippers typically create the highest energy vibrations that tend to be the most damaging to the user. In fact, the frequency and magnitude of these vibrations often cause relatively serious traumatic conditions in the users, the most common of which is the occupationally-disabling vibration syndrome.

Numerous studies of the vibration problem and attempted solutions thereto have been essayed, directed mainly to the provision of various forms of shock-absorbing materials interposed between the tool handle and the moving part of the tool. Typical of such part-solutions is the disclosure in U.S. Pat. No. 3,968,843 issued to Shotwell, wherein a block of rubber is disposed between the handle and barrel of a pneumatic percussion tool. Applicant has attempted other solutions to the vibration problem as disclosed in U.S. Pat. Nos. 4,648,468; 4,771,833; 4,905,772 5,027,910; 5,031,323; 5,054,562; 7,401,662; and, 7,610,968, all of which are incorporated by reference herein in their entireties.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1 provides a perspective view of a first embodiment of a tool in accordance with the present disclosure.

FIG. 2 provides a side view of the first embodiment of a tool in accordance with the present disclosure.

FIG. 3 provides a perspective view of the first embodiment of a tool in accordance with the present disclosure with the beehive removed for clarity.

FIG. 4 provides a perspective view of a second embodiment of a tool in accordance with the present disclosure.

FIG. 5 provides a perspective view of a first embodiment of a skeleton and sleeve that may be used with a tool according to the present disclosure.

FIG. 6A provides a perspective view of the first embodiment of a skeleton and sleeve that may be used with a tool according to the present disclosure.

FIG. 6B provides a cutaway view of the first embodiment of a skeleton that may be used with a tool according to the present disclosure, wherein the sleeve is removed for purposes of clarity.

FIG. 7 provides an exploded view of the first embodiment of a tool in accordance with the present disclosure.

FIG. 8 provides perspective view of a first embodiment of a throttle assembly that may be used with a tool configured in accordance with the present disclosure wherein the throttle assembly is open.

FIG. 8A provides a cross-sectional view of the throttle assembly shown in FIG. 8 wherein the throttle assembly is open.

FIG. 8B provides a cross-sectional view of the throttle assembly shown in FIG. 8 wherein the throttle assembly is closed.

### DETAILED DESCRIPTION—LISTING OF ELEMENTS

| ELEMENT DESCRIPTION | ELEMENT # |
|---|---|
| Tool | 10 |
| Lock pin | 12 |
| Exhaust deflector | 14 |
| Inlet bushing | 16 |
| Rivet gun | 18 |
| Skeleton | 20 |
| Main body | 22 |
| Valve box void | 22a |
| Throttle casing | 24 |
| Throttle void | 24a |
| Valve box feed passage | 25 |
| Handle member | 26 |
| Fluid inlet passage | 26a |
| Distal protrusion | 28 |
| Barrel | 30 |
| Work piece engager | 30a |
| Valve box assembly engager | 30b |
| Ball bearing retainer | 32 |
| Quick change retainer | 34 |
| Beehive | 36 |
| Beehive cover | 36a |
| Piston | 38 |
| Valve box assembly | 40 |
| Valve case | 42 |
| Valve | 44 |
| Valve case dowel | 46 |
| Valve case lid | 48 |
| Throttle assembly | 50 |
| Throttle body | 51 |
| Threads | 51a |
| Outlet port | 51b |
| Large O-ring seat | 51c |
| Inlet port | 51d |
| Throttle stem | 52 |
| Small O-ring seat | 52a |
| Spring interface | 52b |
| Throttle button interface | 52c |
| Intermediate portion | 52d |
| Intermediate O-ring seat | 52e |
| Throttle button | 53 |
| Spring | 54 |
| Intermediate O-ring | 56 |
| Large O-ring | 57 |
| Small O-ring | 58 |
| Sleeve | 60 |
| Handle | 61 |
| Throttle Guard | 62 |
| Neck | 64 |
| Palm contour | 66 |
| Distal stop | 68 |

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

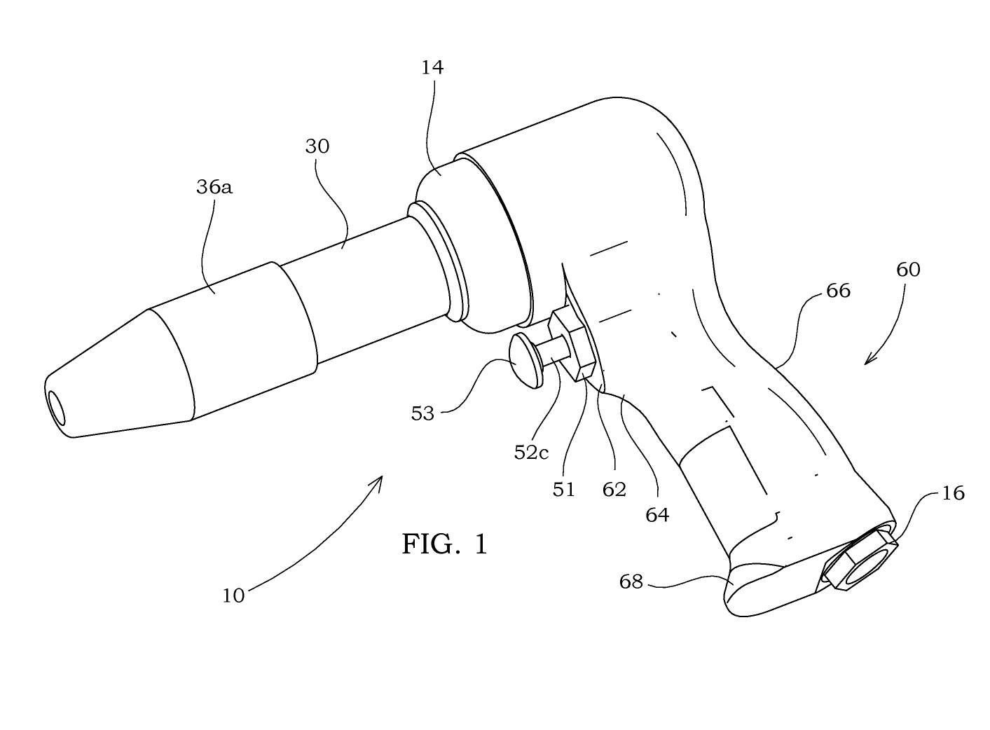

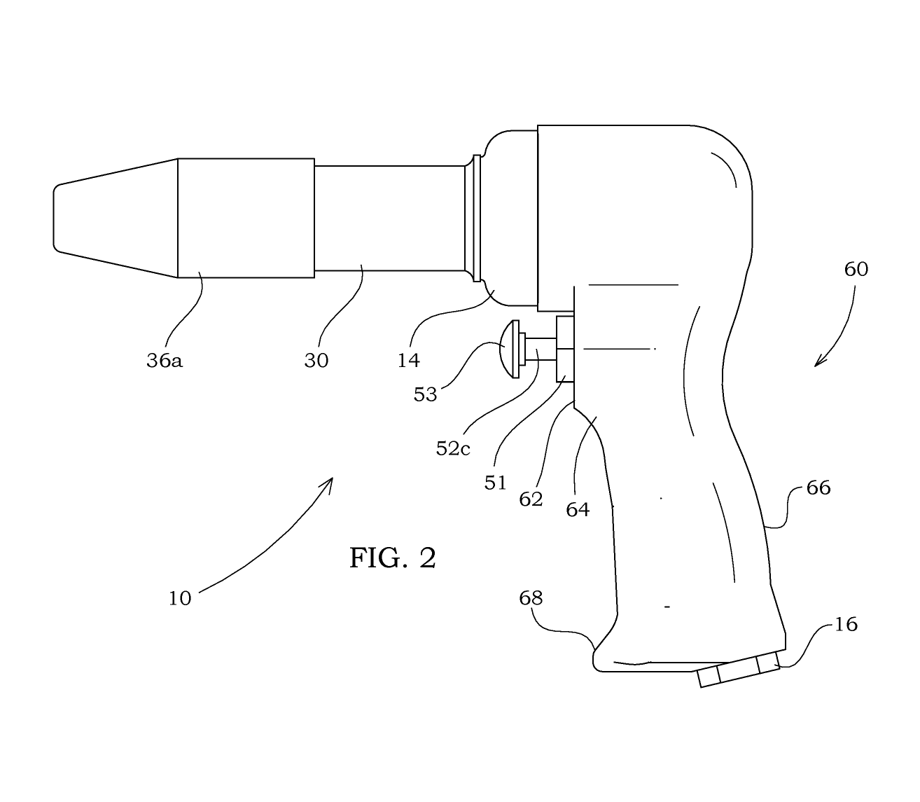

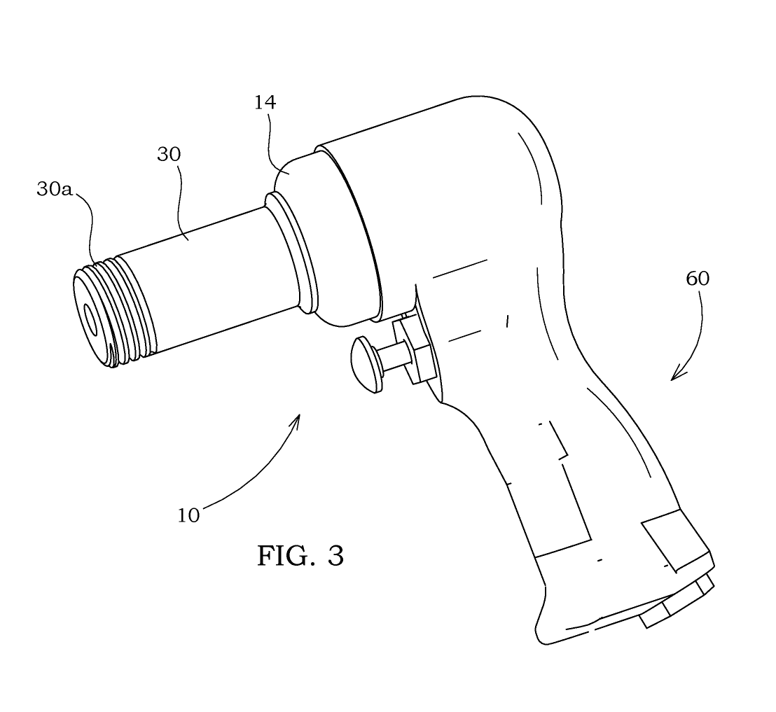

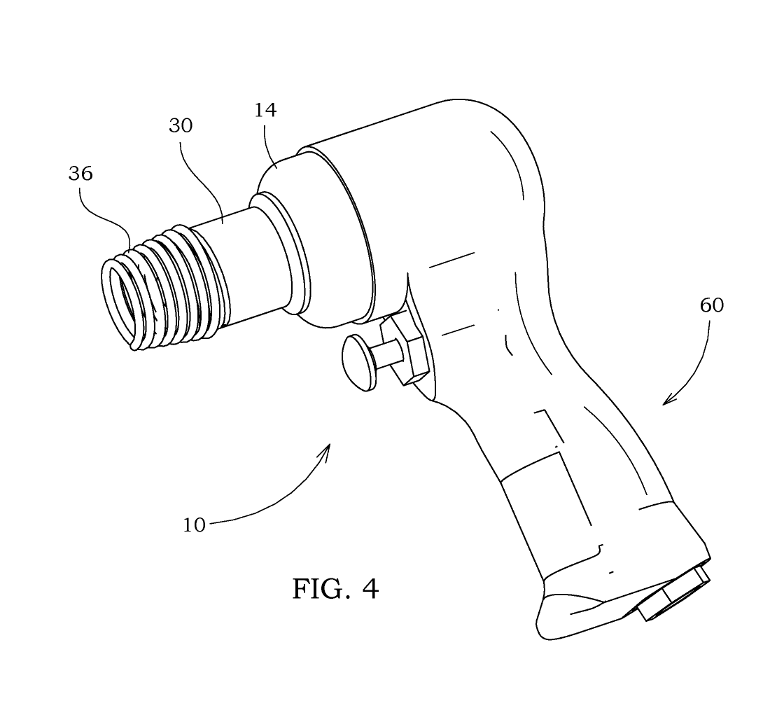

Referring now to the drawings, wherein like reference numerals designate identical or corresponding parts throughout the several views, FIGS. 1 & 3 provide perspective views of a first embodiment of the tool 10 according to the present disclosure. A side view of the first embodiment of the tool 10 is shown in FIG. 2. In FIG. 3, the work piece (e.g., ball bearing retainer 32, quick change retainer 34, beehive 36) have been removed for clarity. FIG. 4 provides a perspective view of a second embodiment of the tool 10, wherein the length of the barrel 30 is shorter than that of the first embodiment.

Referring generally to FIGS. 1-4, the tool 10 as disclosed and claimed herein generally comprises a skeleton 20 (not visible in FIGS. 1-4), barrel 30, valve box assembly 40 (not visible in FIGS. 1-4) positioned in a portion of the skeleton 20, throttle assembly 50 partially positioned within a portion of the skeleton 20, and a handle 61. The barrel 30 may be of any length, with the optimal length thereof varying from one application of the tool 10 to the next. Therefore, the barrel 30 length is in no way limiting to the scope of the tool 10. Furthermore, any work piece may be engaged with the barrel 30 without limitation. Although the various embodiments pictured and described herein are specifically adapted for use as rivet driving tools and/or weld destruct tools, the tool 10 is not so limited. Accordingly, the tool 10 as disclosed and claimed herein extends to any hand tool that causes vibrations to be transmitted to the user during operation.

Generally, the throttle button 53 provides a user interface for manipulating the speed and engagement of the power mechanism of the tool 10. The embodiments of the tool 10 disclosed and pictured herein are adapted for use with a pneumatic system. However, the tool 10 may be powered by other means, including but not limited to pressurized liquid, electricity, and/or a small internal combustion engine. Accordingly, the tool 10 is in no way limited by the type of power source used therewith.

As shown, in the first embodiment of the tool 10 the handle 61 is ergonomically shaped to minimize the fatigue a user experiences during operation. In the first embodiment, the handle 61 is integrally formed with a sleeve 60 that substantially covers the entire exterior surface of the skeleton 20, which is described in detail below. The back side of the handle 61 is comprised of a palm contour 66 to aid in securely gripping the tool 10. A distal stop 68 may be positioned on the distal end of the handle 10 to prevent the user's hand from slipping downward on the handle 10 and provide additional comfort. A throttle guard 62 may be positioned adjacent the throttle assembly 50 to mitigate the risk of pinching during actuation of the throttle assembly 50. Finally, a neck 64 having a reduced periphery may be positioned adjacent the throttle guard 62. The neck 64 may be ergonomically contoured, as shown, so that the user may easily grip the tool 10, and so that the user's thumb and middle finger comfortably and securely rest on the handle 10. The specific shape, dimensions, and/or configuration of the handle 61 and various elements thereof will vary from one embodiment of the tool 10 to the next, and are therefore in no way limiting to the scope of the tool 10.

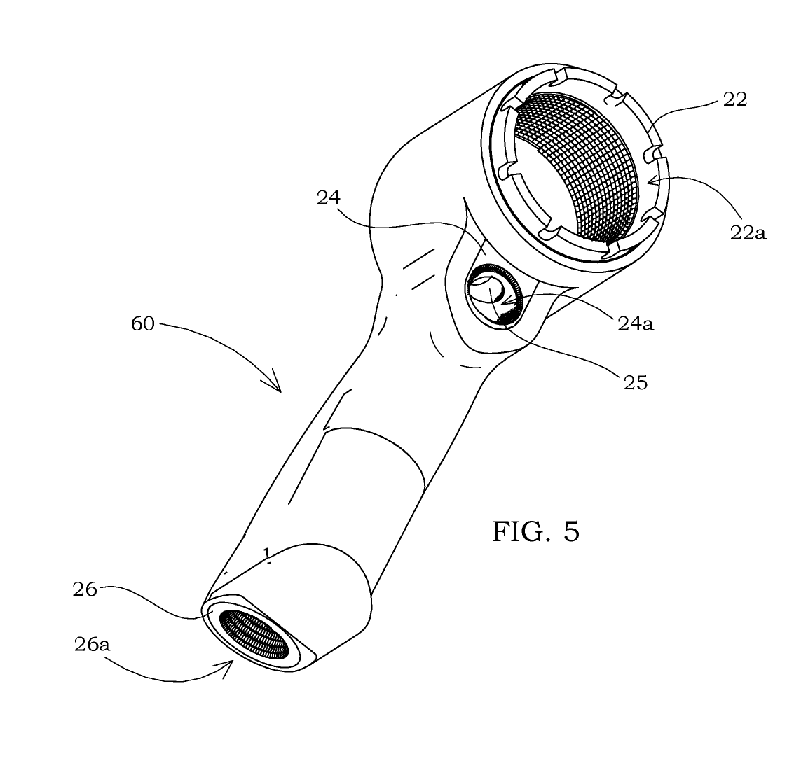

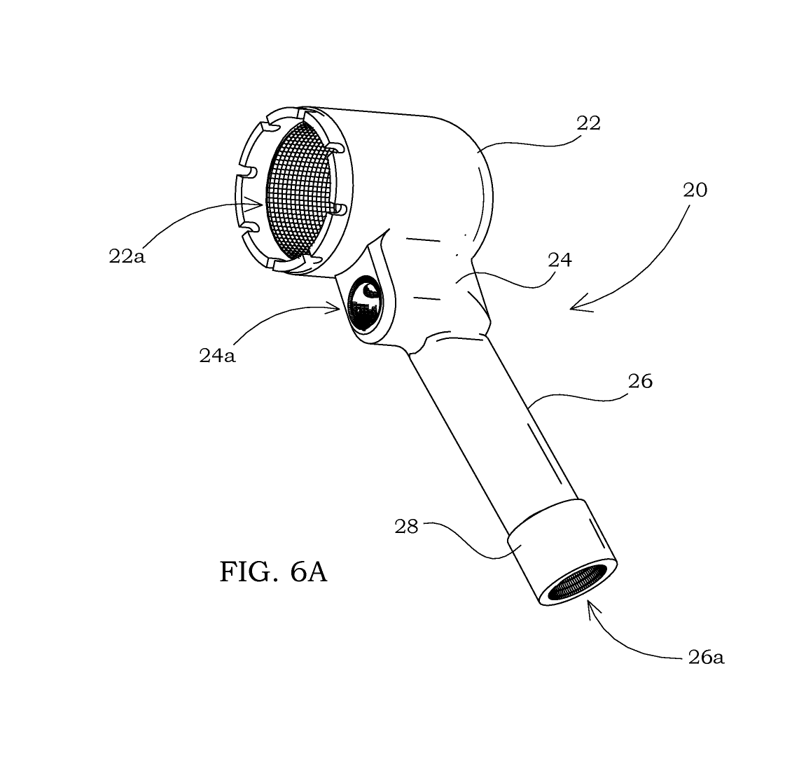

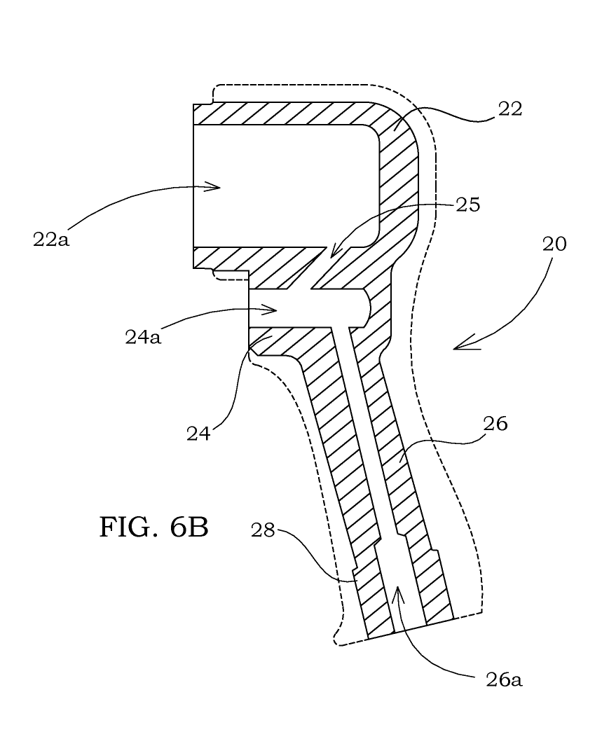

The skeleton 20 and sleeve 60 are shown in perspective view in FIG. 5. As shown, the sleeve 60 may be fashioned to cover substantially the entire exterior surface of the skeleton 20. The thickness of the sleeve 60 may vary depending on the specific location on the skeleton 20 and/or the specific application of the tool 10. A skeleton 20 with the sleeve 60 removed is shown in perspective in FIG. 6A, and in cross-section in FIG. 6B. A comparison of FIGS. 5, 6A & 6B show that the thickness of the sleeve 60 at the handle 61 is greater than the thickness of the sleeve 60 around the main body 20 in the first and second embodiments of the tool 10 as disclosed herein. Accordingly, in most embodiments of the tool 10, less energy is transmitted to the handle 61 than to the main body 22, which reduces fatigue in the user as the main interface point is the handle 61. Other embodiments may have other thicknesses of the sleeve 60 at various positions about the skeleton 20 without limitation.

The sleeve 60 may be constructed of any material suitable for the specific application of the tool 10. Accordingly, the specific material used for the sleeve 60 in no way limits the scope of the tool 10 as disclosed and claimed herein. Certain types of materials that may be used to construct the sleeve 60 include but are not limited to shock-absorbing elastomers (such as polyurethane, polyether eurethane, and/or other polymers), vibration dampening material, natural materials, and/or combinations thereof.

The skeleton 20 may include a main body 22 with a valve box void 22a formed therein. The valve box void 22a may be configured to accept a valve box assembly 40, which is described in detail below. The skeleton 20 may also include a throttle casing 24 having a throttle void 24a formed therein. The throttle void 24a may be configured to accept a throttle assembly 50, which is also described in detail below. A handle member 26 may be integrally formed with the main body 22 and throttle casing 24 and protrude distally therefrom. A distal protrusion 28 may be integrally formed on the most distal portion of the handle member 26, as clearly shown in FIG. 6A. As shown in FIG. 6B, which provides a cutaway view of one embodiment of a skeleton 20, a fluid inlet passage 26a may extend along the length of the handle member 26. The fluid inlet passage 26a may be fluidly connected to a valve box feed passage 25, which may be positioned adjacent the throttle void 24a. The fluid inlet passage 26a serves to provide a pathway for pressurized fluid to reach the throttle assembly 50, which allows the user to regulate the flow of pressurized fluid to the valve box assembly 40. An inlet bushing 16 may be engaged with the distal most end of the fluid inlet passage 26a in the embodiment of the tool 10 pictured herein to create a simple and user friendly interface between the tool 10 and the pressurized supply fluid.

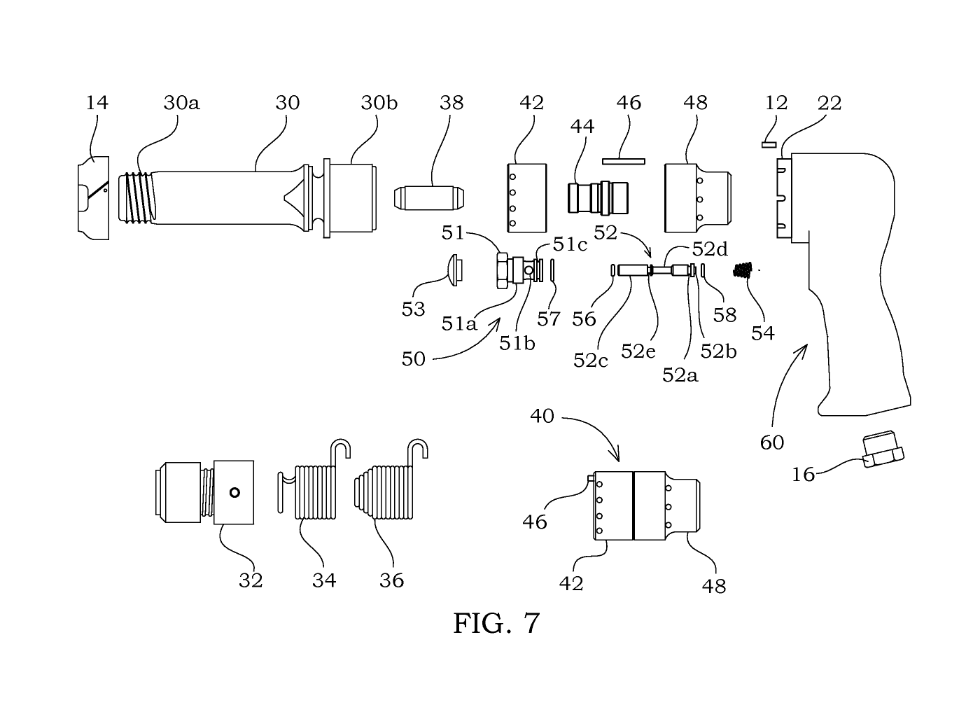

A typical valve box assembly 40 that may be used with the tool 10 is shown in an exploded view in FIG. 7. In this embodiment of a valve box assembly 40, a valve case 42 and valve case lid 48 cooperate to substantially enclose a valve 44. A valve case dowel 46 may be used to ensure the various components of the valve box assembly 40 maintain the proper rotational position with respect to one another. Other types of valve box assemblies 40 may be used with the tool 10 without limitation. Additionally, certain embodiments of the tool 10 may not require a valve box assembly 40, such as electrical or gasoline powered tools 10.

One example of a barrel 30 that may be engaged with a valve box assembly 40 is shown in detail in FIG. 7. The barrel 30 may be engaged with the valve box assembly 40 at the valve box assembly engager 30b, and the barrel 30 may be engaged with a work piece at the work piece engager 30a. Several different types of work pieces are shown in FIG. 7, including a ball bearing retainer 32, quick change retainer 34, and beehive 36. In one embodiment of the beehive 36, a beehive cover 36a is positioned around the exterior surface of the beehive 36 to reduce vibrations and/or energy transfer from the tool 10 to the user (as shown in FIGS. 1-3). The beehive cover 36a may be constructed of any material suitable for the particular application of the tool 10 without limitation, including but not limited to any elastomeric shock-absorbing material and/or vibration dampening material.

In the embodiment of the tool 10 shown in FIG. 7, a piston 38 provides the kinetic energy to the work piece. In this type of tool 10, the piston 38 moves along the length of the barrel 30 due to the motive force of a compressed fluid routed through the valve box assembly 40. Because this type of pneumatic percussive mechanism is generally known to those skilled in the art, further detail thereof will be omitted for purposes of clarity. The barrel 30 (and consequently the valve box assembly 40) may be secured to the skeleton 20 with the exhaust deflector 14. A lock pin 12 may be used to ensure the respective rotational positions of the barrel 30 and skeleton 20 are constant. The piston 38 may be formed of any suitable material for delivery of kinetic energy to the work surface, including but not limited to steel, steel alloys, other metallic alloys, palladium, tungsten, and/or combinations thereof.

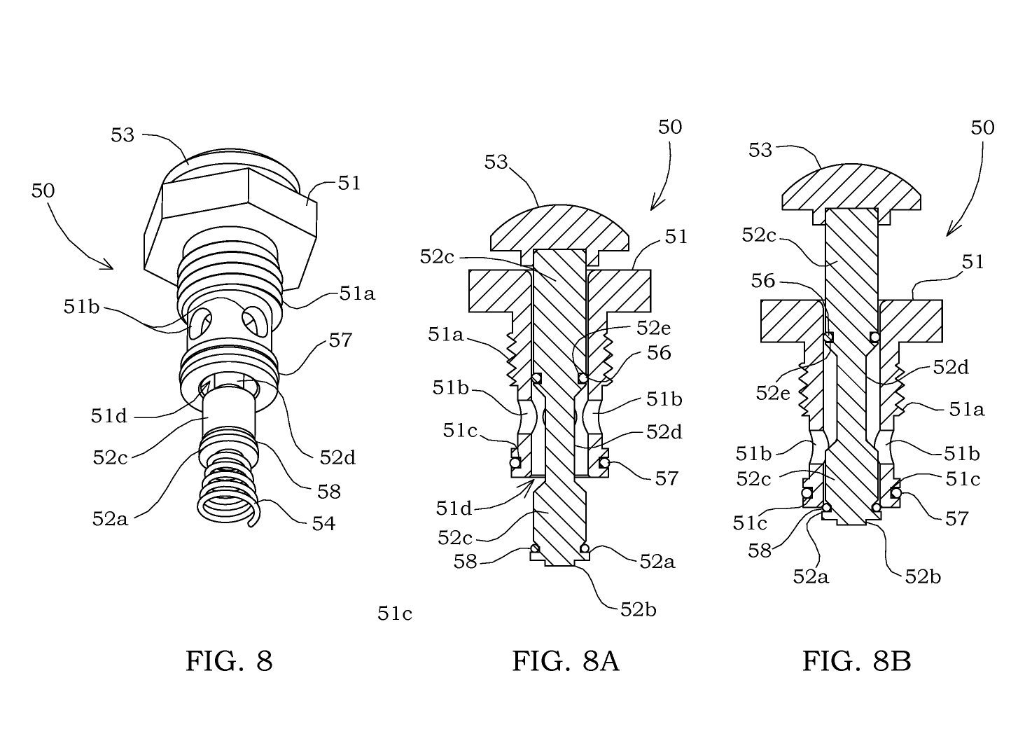

An exploded view of one embodiment of a throttle assembly 50 that may be used with the tool 10 is shown in FIG. 7, and a perspective view thereof is shown in FIG. 8. The throttle assembly 50 generally allows the user to manipulate the flow characteristics of the pressurized fluid to the valve box assembly 40, thereby manipulating the speed and/or force at which the tool 10 operates. A throttle body 51 may be engaged with the skeleton 20 at the throttle casing 24, and a portion of the throttle body 51 may extend into the throttle void 24a. Threads 51a may be fashioned in the exterior of a portion of the throttle body 51 to provide a simple interface between the throttle body 51 and the throttle casing 24, which provides a secure attachment interface therebetween. The portion of the throttle body 51 that extends into the throttle void 24a may be formed with a plurality of outlet ports 51b oriented radially and at least one inlet port 51d oriented axially, as shown in FIG. 8. A large O-ring seat 51c may also be formed in the throttle body 51 adjacent the inlet port 51d, and a large O-ring 57 may be securely positioned in the large O-ring seat 51c. The large O-ring 57 may be configured to create a hermetic seal between the exterior of the throttle body 51 and the throttle void 24a A throttle stem 52 may be configured such that the throttle stem 52 and throttle body 51 are substantially concentric, wherein a portion of the throttle stem 52 passes through the throttle body 51. The throttle stem 52 may be formed with a spring interface 52b at the interior-most end of the throttle stem 52 and a throttle button interface 52c at the exterior-most end. An intermediate portion 52d of reduced cross-sectional thickness may connect the throttle button interface 52c with the spring interface 52b. An intermediate O-ring seat 52e may be formed in the throttle stem 52 adjacent the union of the throttle button interface 52c and the intermediate portion 52d. A small O-ring seat 52a may be formed in the throttle stem 52 adjacent the spring interface 52b. A small O-ring 58 may be securely positioned in the small O-ring seat 51c and an intermediate O-ring 56 may be positioned in the intermediate O-ring seat 52e. A throttle button 53 may be engaged with the throttle stem 52 at the throttle button interface 52c to provide the user with a convenient structure for actuating the throttle assembly 50. A spring 54 may be positioned in the throttle void 24a between the interior of the throttle void 24a and the spring interface 52b to bias to the throttle stem 52, which bias urges the throttle stem 52 outward from the throttle void 24a.

When the pressurized fluid is supplied to the tool 10 via the fluid inlet passage 26a, the pressurized fluid in combination with the spring 54 cause the throttle stem 52 to be forced outward until the small O-ring 58 is in contact with the periphery of the inlet port 51d of the throttle body 51. Because the large O-ring 57 creates a hermetic seal between the exterior of the throttle body 51 and the throttle void 24a, no pressurized fluid passes through the throttle assembly 50 when the tool 10 is in this state.

However, when the throttle stem 52 is acted upon by an outside force (e.g., a user pressing the throttle button 53 inwardly toward the throttle void 24a), the spring is compressed 54 and the small O-ring 58 moves away from the periphery of the inlet port 51d, as shown in FIG. 8. This allows pressurized fluid to flow from the fluid inlet passage 26a into the inlet port 51c, and out through the outlet ports 52b into the valve box feed passage 25 and to the valve box assembly 40. The intermediate O-ring 56 creates a hermetic seal between the throttle stem 52 and the throttle body 51 adjacent the threads 51a so that pressurized fluid does not leak out from the throttle assembly 50 adjacent the throttle button 53. The throttle assembly 50 may be configured so that the user may adjust the amount of pressurized fluid that passes through the throttle body 51 during operation of the tool 10 by an infinite amount, thereby increasing the usefulness of the tool 10 for multiple applications. For example, when the user requires maximum power, the user may fully depress the throttle button 53 and allow maximum pressurized fluid flow to the valve box assembly 40. When the user requires less than maximum power, the user may depress the throttle button 53 to a position intermediately located between full depression and no depression, thus allowing less-than-maximum pressurized fluid flow to the valve box assembly 40.

The throttle casing 24 and throttle assembly 50 of the tool 10 are configured such that the longitudinal axis thereof is not parallel to the longitudinal axis of the fluid inlet passage 26a, which configuration is a departure from that found in the prior art. This non-parallel configuration allows for a reduced cross-sectional area of the handle member 26 of the skeleton 20, which in turn allows the handle 61 to include more elastomeric and/or vibration dampening material, which means that more elastomeric and/or vibration dampening material may be placed between the skeleton 20 and the user during operation. This configuration also allows the handle 61 to include more ergonomic contours as compared with handles on prior art tools, which reduces user fatigue and likelihood of injury when using the tool 10 disclosed herein as compared to using prior art tools.

The configuration of the sleeve 60 in the illustrative embodiment of the tool 10 will become apparent from a comparison of FIGS. 5 & 6A. The reduced thickness of the handle member 26 with respect to those of the prior art allows the placement of more handle 61 material in that area, which is the primary interface between the user and the tool 10. Additionally, the configuration of the throttle casing 24 allows for myriad orientations and/or configurations of the throttle guard 62 and neck 64. The illustrative embodiment of the tool 10 includes a throttle guard 62 formed in the sleeve 60. The throttle guard 62 is positioned adjacent the throttle body 51 and is formed substantially as a raised portion in the illustrative embodiment. This type of throttle guard 62 mitigates the risk of pinching between the back side of the throttle button 53 and any portion of the tool 10 during actuation of the throttle assembly 50. The sleeve 60 may also include a neck 64, which may be fashioned substantially as a reduced-periphery portion adjacent the proximal end of the handle 61. This type of neck 64 aids in user comfort and secure handling of the tool 10. A distal stop 68 may be positioned around the distal protrusion 28 of the skeleton 20, which prevents unwanted slippage of the tool 10 during use. The handle 61 may also be formed with a palm contour 66, as best shown in FIGS. 1-3. The palm contour 66 in the disclosed embodiments increases user comfort during use and decreases user fatigue.

From the description and figures herein, it will be apparent to those skilled in the art that the embodiment of the tool 10 shown herein includes a sleeve 60 positioned on the exterior of a skeleton 20. The sleeve 60 mitigates the vibration and/or kinetic energy transferred from the tool 10 to the user during operation of the tool 10. The optimal dimensions and/or configuration of the skeleton 20, barrel 30, work piece, valve box assembly 40, throttle assembly 50, and/or sleeve 60 will vary from one embodiment of the tool 10 to the next, and are therefore in no way limiting to the scope thereof. The skeleton 20, barrel 30, valve box assembly 40, and throttle assembly 50 may be formed of any material that is suitable for the application for which the tool 10 is used. Such materials include but are not limited to metals and their metal alloys, polymeric materials, and/or combinations thereof.

Although the specific embodiments pictured and described herein pertain to a tool 10 powered by a pressurized fluid, the tool 10 may be configured so that it may be powered by other methods, as previously described. Accordingly, the scope of the tool 10 is in no way limited by the specific power mechanism used therewith.

Having described the preferred embodiment, other features, advantages, and/or efficiencies of the tool 10 will undoubtedly occur to those versed in the art, as will numerous modifications and alterations of the disclosed embodiments and methods, all of which may be achieved without departing from the spirit and scope of the tool 10 as disclosed and claimed herein. It should be noted that the tool 10 is not limited to the specific embodiments pictured and described herein, but is intended to apply to all similar apparatuses for mitigating and/or reducing the frequency, intensity, and/or number of vibrations and/or energy transmitted from a tool 10 to a user during operation of the tool 10, or generally reducing the kinetic energy transmitted to a user during operation of a tool 10. Modifications and alterations from the described embodiments will occur to those skilled in the art without departure from the spirit and scope of the tool 10.

1. A tool comprising:
a. a skeleton, wherein said skeleton is configured to cooperatively engage a kinetic energy providing member, wherein said skeleton is configured to engage a throttle assembly that controls the amount of kinetic energy said tool delivers, and wherein said skeleton is configured with a handle member;
b. a barrel cooperatively engaged with said skeleton at a first end of said barrel, wherein a second end of said barrel is cooperatively engaged with a work piece for delivery of kinetic energy; and
c. a throttle assembly cooperatively engaged with said skeleton, wherein said throttle assembly is configured to allow a user to manipulate the amount of kinetic energy at said work piece, and wherein said throttle assembly and said handle member are configured to ergonomically optimize the cross-sectional area of said handle member.

2. The tool according to claim 1 wherein said tool is further defined as being electrically powered.

3. The tool according to claim 1 wherein said kinetic energy providing member is further defined as a valve box assembly.

4. A tool comprising:
a. a skeleton comprising:
i. a main body having a valve box void formed therein;
ii. a throttle casing having a throttle void formed therein;
iii. a valve box feed passage connecting said valve box void and said throttle void;
iv. a handle member extending distally from said throttle casing;
v. a fluid inlet passage;
b. a valve box assembly configured to convert energy from a pressurized fluid source into kinetic energy, wherein said valve box assembly is cooperatively engaged with said valve box void;
c. a barrel comprising:
i. a valve box assembly engager cooperatively engaged with said valve box assembly;
ii. a work piece engager opposite said valve box assembly engager, wherein said barrel transfers a portion of the kinetic energy from said valve box assembly to a work piece;
d. a throttle assembly configured to allow a user to manipulate the amount of kinetic energy at said work piece, wherein said throttle assembly is cooperatively engaged with said throttle void, and wherein said throttle assembly, said throttle casing, said handle member, and said fluid inlet passage are configured to ergonomically optimize the cross-sectional area of said handle member.

5. The tool according to claim 4 wherein said tool further comprises a sleeve covering a portion of said skeleton.

6. The tool according to claim 5 wherein said sleeve is further defined as comprising:
a. a handle covering a portion of said handle member;
b. a palm contour adjacent said handle; and
c. a neck adjacent said throttle casing.

7. The tool according to claim 6 wherein said throttle void and said handle member are further defined as having longitudinal axes configured to be substantially perpendicular with respect to one another.

8. The tool according to claim 7 wherein said throttle assembly is further defined as comprising:
a. a throttle body cooperatively engaged with said throttle void;
b. a throttle stem cooperatively engaged with said throttle body, wherein said throttle body and said throttle stem are configured such that the relative position of said throttle stem with respect to said throttle body affect the amount of kinetic energy delivered to said work piece.

9. The tool according to claim 8 wherein said throttle assembly further comprises a throttle button engaged with a first end of said throttle stem.

10. The tool according to claim 9 wherein said throttle assembly further comprises a spring, wherein said spring is configured to bias said throttle stem away from said skeleton.

11. The tool according to claim 10 wherein said tool is further defined as being configured to delivery kinetic energy to said work piece via a piston, wherein said piston is propelled a predetermined distance along the length of said barrel via said pressurized fluid.

12. The tool according to claim 11 wherein said piston is further defined as being constructed of a group consisting of steel, iron, titanium, aluminum, molybdenum, tantalum, tungsten, and boron carbide.

13. The tool according to claim 12 wherein said throttle body is further defined as comprising an outlet port formed on the side of said throttle body and an inlet port formed in a first end of said throttle body.

14. A method of minimizing the kinetic energy imparted from a tool to a user, said method comprising the steps of:
a. configuring a throttle assembly of said tool such that a throttle stem of said throttle assembly is substantially perpendicular to a handle member of said tool;
b. reducing the cross-sectional area of said handle member of said tool; and
c. coating at least a portion of said handle member with a sleeve, wherein said sleeve is configured to dampen vibrations transmitted from said tool to said user.
